(19) United States
(12) Patent Application Publication
(10) Pub. No.: US 2019/0384087 A1
(43) Pub. Date: Dec. 19, 2019

(54) MANUFACTURING METHOD OF GRAPHENE ELECTRODE AND LIQUID CRYSTAL DISPLAY PANEL

(71) Applicant: Haijun WANG, Shenzhen, Guangdong (CN)

(72) Inventor: Haijun WANG, Shenzhen, Guangdong (CN)

(73) Assignee: Shenzhen China Star Optoelectronics Technology Co., Ltd., Shenzhen, Guangdong (CN)

(21) Appl. No.: 15/545,715

(22) PCT Filed: Mar. 28, 2017
(86) PCT No.: PCT/CN2017/078473

§ 371 Date: Jul. 23, 2017

(30) Foreign Application Priority Data
Mar. 14, 2017 (CN) 201710155073.1

(51) Int. Cl. G02F 1/1343

(52) U.S. Cl. CPC G02F 1/13439; G02F 1/133305

(57) ABSTRACT

Disclosed is a manufacturing method of a graphene electrode. In the manufacturing method, after the substrate as a target substrate covers the graphene layer, the laser light irradiates on the substrate corresponding to the desired pattern area for manufacturing the electrode to transfer graphene on the substrate with the laser light. Since only the graphene in the desired pattern area is transferred, the graphene transferred on substrate directly forms the graphene electrode which is patterned. Apparently, the manufacturing method of the graphene electrode according to the present invention can simplify the manufacturing process and can reduce the difficulty of patterning the graphene electrode and the processing cost. The present invention further provides a liquid crystal display panel, comprising the graphene electrode manufactured by the foregoing method.

### CROSS REFERENCE

This application claims the priority of Chinese Patent Application No. 201710155073.1, entitled “Manufacturing method of graphene electrode and liquid crystal display panel”, filed on Mar. 14, 2017, the disclosure of which is incorporated herein by reference in its entirety.

### FIELD OF THE INVENTION

The present invention relates to a graphene electrode, more particularly to a manufacturing method of a graphene electrode and a liquid crystal display panel.

### BACKGROUND OF THE INVENTION

Graphene is stripped from the graphite material and is a two-dimensional crystal composed of carbon atoms with only one layer of atomic thickness. Graphene is currently the thinnest material and is the material having the highest intensity in nature, and has an extremely high thermal conductivity. The excellent thermal conductivity makes graphene be expected as a cooling material of the future of ultra-large-scale nano-integrated circuit. In addition, the stable lattice structure of graphene makes it possess an excellent conductivity. Because the graphene has the excellent performance, it has been widely used in industry. For instance, it is applied in a display device, and is used as a graphene electrode.

At present, the manufacture of graphene electrode mainly is: usage of the transfer method, which specifically is: transferring the graphene onto the required substrate, and etching the graphene by micromachining, thereby forming a preset pattern; or, preparing the patterned metal material in advance, and forming the graphene on the metal pattern by chemical vapor deposition (CVD), and then transferring the same onto the required substrate. Although the method according to prior art can manufacture the graphene electrode of particular pattern, the manufacturing process is complicated, and the quality of the graphene is lower. Moreover, the aforesaid method makes the graphene electrode patterning more difficult and the cost is higher. Therefore, there is a need to develop a new manufacturing method of a graphene electrode so that it is more widely used in the field of electronic devices.

### SUMMARY OF THE INVENTION

The embodiment of the present invention provides a manufacturing method of a graphene electrode, which can simplify the manufacturing process and can reduce the difficulty of patterning the graphene electrode to decrease the processing cost in advance.

First, the embodiment of the present invention provides a manufacturing method of a graphene electrode, comprising steps of:

providing a support plate and forming a graphene layer on the support plate;

providing a substrate and covering the graphene layer with the substrate;

irradiating the substrate corresponding to a predetermined pattern area of the graphene electrode with laser light so that graphene at a position where the laser light irradiates is adsorbed on the substrate;

cooling the substrate so that a portion of the substrate irradiated by the laser light is adhered with the graphene layer which is adsorbed; and

separating the substrate and the graphene layer adhered to the substrate from the support plate to form the graphene electrode which is patterned on the substrate.

The substrate is a flexible substrate made of a polyethylene terephthalate material or a polyimide material.

After the step of providing the support plate and forming the graphene layer on the support plate, the manufacturing method further comprises a step of: baking the support plate bearing the graphene layer at 50 degrees Celsius to 80 degrees Celsius.

The laser light is carbon dioxide laser, semiconductor laser or fiber laser.

The step of irradiating the substrate corresponding to the predetermined pattern area of the graphene electrode with the laser light comprises:

moving a laser beam on the substrate along the desired pattern area of the graphene layer; or

irradiating the substrate with a planar laser light source and a patterned mask to irradiate the substrate corresponding to the desired pattern area of the graphene layer with the laser light through the mask.

The step of irradiating the substrate corresponding to the desired pattern area of the graphene layer with the laser light so that the desired pattern area of the graphene layer is adsorbed on the substrate comprises:

graphene of the desired pattern area of the graphene layer capturing energy of the laser light to generate heat and the heat melting the substrate in a region irradiated by the laser light to adsorb the graphene which contacts the substrate at a melting position by melting the substrate.

The step of cooling the substrate so that the portion of the substrate irradiated by the laser light is adhered with the graphene layer which is adsorbed comprises:

cooling the portion of the substrate, which is melted to be solidified to adhere the graphene adsorbed at the portion of the substrate, which is melted, on the substrate.

The graphene layer is formed with graphene and/or graphene oxide as a raw material by spraying, coating or chemical vapor deposition.

As the graphene layer comprises the graphene oxide, after the desired pattern area of the graphene layer is irradiated by the laser light, the graphene oxide is reduced to be reduced graphene oxide which is adsorbed and adhered on the substrate.

Second, the embodiment of the present invention further provides a liquid crystal display panel, comprising a graphene electrode. The graphene electrode is manufactured by the aforesaid manufacturing method.

In the manufacturing method of the graphene electrode and the liquid crystal display panel provided by the embodiment of the present invention, the etching is not required for the patterning of the graphene electrode and the patterned metal material in combination with the CVD process is not required for the patterning of the graphene, either. In the manufacturing method of the present invention, the laser light directly irradiates on the predetermined pattern area of the graphene electrode. The graphene and/or the reduced graphene oxide of the predetermined pattern area are adsorbed and adhered on the substrate and can be separated from the graphene, which is not irradiated by the laser light to form the graphene electrode which is patterned on the substrate. Not only the manufacturing process is simplified but also the difficulty of the patterning of the graphene electrode is reduced. Thus, the processing cost is greatly reduced.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a flowchart of a manufacturing method of a graphene electrode provided by the embodiment of the present invention.

FIG. 2(a) to FIG. 2(e) are process diagrams of respective steps as manufacturing the graphene electrode by the manufacturing method shown in FIG. 1.

### DETAILED DESCRIPTION OF PREFERRED EMBODIMENTS

For better explaining the technical solution and the effect of the present invention, the present invention will be further described in detail with the accompanying drawings in the specific embodiments. It is clear that the described embodiments are part of embodiments of the present application, but not all embodiments. Based on the embodiments of the present invention, all other embodiments to those of ordinary skill in the premise of no creative efforts obtained, should be considered within the scope of protection of the present invention.

Besides, the following descriptions for the respective embodiments are specific embodiments capable of being implemented for illustrations of the present invention with referring to appended figures. For example, the terms of up, down, front, rear, left, right, interior, exterior, side, etcetera are merely directions of referring to appended figures. Therefore, the wordings of directions are employed for explaining and understanding the present invention but not limitations thereto.

In the description of the invention, which needs explanation is that the term “installation”, “connected”, “connection” should be broadly understood unless those are clearly defined and limited, otherwise, For example, those can be a fixed connection, a detachable connection, or an integral connection; those can be a mechanical connection, or an electrical connection; those can be a direct connection, or an indirect connection with an intermediary, which may be an internal connection of two elements. To those of ordinary skill in the art, the specific meaning of the above terminology in the present invention can be understood in the specific circumstances.

Besides, in the description of the present invention, unless with being indicated otherwise, “plurality” means two or more. In the present specification, the term “process” encompasses an independent process, as well as a process that cannot be clearly distinguished from another process but yet achieves the expected effect of the process of interest. Moreover, in the present specification, any numerical range expressed herein using “to” refers to a range including the numerical values before and after “to” as the minimum and maximum values, respectively. In figures, the same reference numbers will be used to refer to the same or like parts.

The embodiment of the present invention provides a manufacturing method of a graphene electrode, which can simplify the manufacturing process and can reduce the difficulty of patterning the graphene electrode to decrease the processing cost. The detail descriptions are respectively introduced below.

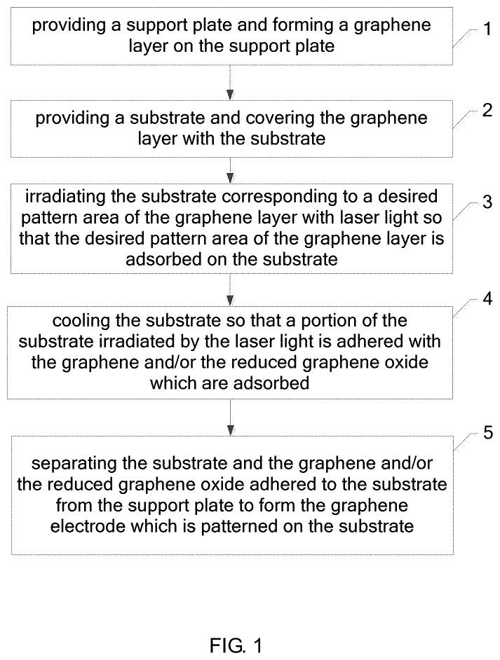

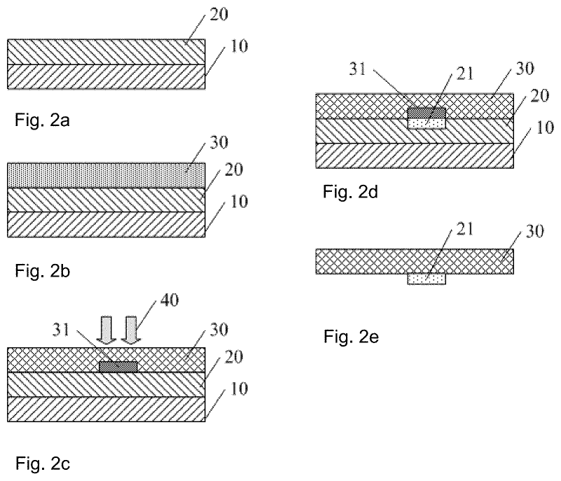

Please refer to FIG. 1. FIG. 1 is a flowchart of a manufacturing method of a graphene electrode provided by the embodiment of the present invention. Please refer to FIG. 2(a) to FIG. 2(e), together. FIG. 2(a) to FIG. 2(e) are process diagrams of respective steps as manufacturing the graphene electrode by the manufacturing method shown in FIG. 1. FIG. 2(a) to FIG. 2(e) respectively correspond to the respective steps of the manufacturing method of the graphene electrode shown in FIG. 1. In the embodiment of the present invention, the manufacturing method of the graphene electrode at least comprises the following steps.

Step 1, providing a support plate and forming a graphene layer on the support plate.

In one embodiment of the present invention, the type of support plate is not limited and can be a support plate made of glass, plastic or other materials. The graphene layer can be formed graphene and/or graphene oxide. In the embodiment of the present invention, the film formed by any one of the graphene and graphene grape or both is referred as a graphene layer in the following.

In one embodiment of the present invention, after the graphene and/or graphene oxide are dispersed into alcohol or other similar solutions, they can be spray coated or spin coated on the support plate to form the graphene layer. In another embodiment of the present invention, the graphene layer can also be formed on the support plate by Chemical Vapor Deposition (CVD). In the present invention, the formation process of the graphene layer is not specifically defined.

In one embodiment of the present invention, after the graphene layer is formed on the support plate, the support plate bearing the graphene layer is baked at 50 degrees Celsius to 80 degrees Celsius to remove the solution in the graphene layer or to dry the support plate and the graphene layer.

The structure formed by Step 1 is shown in FIG. 2(a). A graphene layer 20 composed by graphene and/or graphene oxide is formed on the support plate 10.

Step 2, providing a substrate and covering the graphene layer with the substrate.

The substrate is a target substrate of a display panel for bearing the graphene layer transferred from the support plate so that the graphene layer can be used to be electrode for the display panel in the following. The substrate can be a flexible substrate manufactured by polyethylene terephthalate (PET) or polyimide (PI). The material of the substrate is not specifically defined in the present invention.

Please refer to FIG. 2(b). The substrate 30 covers on the graphene layer 20 so that the graphene layer 20 is sandwiched between the support plate 10 and the substrate 30. The substrate 30 is in contact with the underlying graphene layer 20.

Step 3, irradiating the substrate corresponding to a desired pattern area of the graphene layer with laser light so that the desired pattern area of the graphene layer is adsorbed on the substrate.

In one embodiment of the present invention, the desired pattern area of the graphene layer is arranged corresponding to the pattern required to the graphene electrode.

Since the laser light can reduce the graphene oxide in the graphene layer to form the reduced graphene oxide, the graphene layer can have a better conductivity for overcoming the low conductivity issue of the graphene oxide. Therefore, in one embodiment of the present invention, as the graphene layer is formed by the graphene, the substrate where the laser light irradiates is adsorbed with the graphene; as the graphene layer is formed by the graphene oxide, the substrate where the laser light irradiates is adsorbed with the reduced graphene oxide after reduction; and as the graphene layer is formed by the graphene and the graphene oxide, the substrate where the laser light irradiates is adsorbed with the graphene and the reduced graphene oxide.

Please refer to FIG. 2(c). In one embodiment of the present invention, by irradiating the substrate 30 corresponding to the desired pattern area of the graphene layer 20 with the laser light 40, the graphene and/or graphene oxide of the desired pattern area of the graphene layer 20 capture energy of the laser light 40 to generate heat and the heat melts the substrate 30 in a region irradiated by the laser light. The melted portion (the portion indicated with number 31 in FIG. 2(c)) of the substrate 30 can adsorb the graphene and/or the reduce graphene oxide after reduction which contact the melted portion of the substrate. In one embodiment of the present invention, the time that the laser light 40 irradiates is controlled so that the irradiated area of the substrate 30 is faintly melted. After the graphene layer 20 is heated, the adsorption force with the substrate 30 will also be enhanced to be better adsorbed on the melted portion 31 of the substrate 30. The substrate 30 where is not irradiated with laser light remains to be just cover on the graphene layer 20 and cannot adsorb the graphene layer 20. In such way, the laser light only irradiates on the substrate 30 corresponding the desired pattern portion of the graphene electrode so that the predetermined pattern can adsorb the graphene and/or the reduced graphene oxide.

In one embodiment of the present invention, the laser light source, such as carbon dioxide laser, semiconductor laser or fiber laser can irradiate the graphene layer and the type of the laser light source is not specifically limited in the present invention as long as the light irradiation can heat the graphene layer to melt the irradiated area of the substrate 30 for promoting the adsorption force of the substrate and the graphene layer.

In one embodiment of the present invention, the laser light has a wavelength in a range of 500 nm to 1200 nm. The output power range is 300 mW to 1500 mW. The scan speed is 5 mm/sec to 10 mm/sec.

In one embodiment of the present invention, the laser source is a pen-like structure and the irradiating light is a relatively concentrated laser beam. The laser beam is controlled to move on the substrate along the desired pattern of the graphene electrode and can heat the position of substrate corresponding to the desired pattern of the graphene electrode so that the desired pattern is adsorbed with the graphene. Apparently, the aforesaid laser light irradiation has a high utilization of the laser light. Since moving according to the desired pattern of the graphene electrode is strictly required, the control accuracy requirement of the laser light is higher.

In one embodiment of the present invention, the substrate can also be irradiated with a planar laser light source in cooperation of a patterned mask to irradiate the substrate corresponding to the desired pattern area of the graphene layer with the laser light through the mask. Thus, the irradiation to the substrate corresponding to the desired pattern area of the graphene can be achieved and the portion of the substrate which is shielded by the mask is not irradiated by the laser light. In such way, the irradiation to the desired pattern area of the graphene layer can be accomplished in one time without repeatedly adjusting the laser light source. It can be understood that the pattern of the mask is arranged corresponding to the pattern required to the graphene electrode.

Apparently, in the foregoing laser light irradiation, since the method of large area irradiation in cooperation with the pattern mask is utilized, the efficiency is higher and the control accuracy requirement of the laser light is lower. However, the utilization of the laser light is lower. Therefore, in the actual processing, the aforesaid two ways of laser light irradiations can be selected for the actual production conditions. Alternatively, the aforesaid two ways of laser light irradiations can combined.

Step 4, cooling the substrate so that a portion of the substrate irradiated by the laser light is adhered with the graphene and/or the reduced graphene oxide which is adsorbed.

In one embodiment of the present invention, since the portion of the substrate irradiated by the laser light is melted by the heat generated by the graphene layer, the portion of the substrate melted will be re-solidified as the substrate is cooled to be adhered with the graphene and/or the reduced graphene oxide which is adsorbed.

Please refer to FIG. 2(d). Since the portion (the portion indicated with number 31) of the substrate 30 irradiated by the laser light 40 is faintly melted by the heat generated by the graphene layer 20, the melted portion (the portion indicated with number 21 in FIG. 2(d)) of the substrate 30 can adsorb the graphene and/or the reduce graphene oxide after reduction which contact the melted portion of the substrate. Therefore, the portion of the substrate 30 melted will be re-solidified as the substrate 30 is cooled and the graphene and/or the reduced graphene oxide (the portion indicated with number 21 in FIG. 2(d)) which is adsorbed is adhered on a position where the substrate 30 is solidified. The graphene and/or the reduced graphene oxide can be adhered on the substrate 30 according to the predetermined pattern of the graphene electrode.

Step 5, separating the substrate and the graphene and/or the reduce graphene oxide adhered to the substrate from the support plate to form the graphene electrode which is patterned on the substrate.

After the foregoing Step 4, the substrate is adhered with the graphene and/or the reduce graphene oxide only in the area irradiated by the laser light. In the area where is not irradiated with the laser light, the substrate merely covers on the graphene layer and is not adhered with the graphene layer. Therefore, as separating the substrate from the support plate, only the graphene and/or the reduce graphene oxide adhered on the substrate will be separated from the graphene layer, thus to form the graphene electrode which is patterned on the substrate. The portion of the graphene layer, which is not irradiated by the laser light, is not adhered on the substrate and cannot be separated from the support plate along with the substrate, ultimately, remains on the support plate.

Please refer to FIG. 2(e). Since the area irradiated by the laser light is arranged corresponding to the pattern required to the graphene electrode, only the position corresponding to the desired pattern of the graphene electrode is adhered with the graphene and/or the reduce graphene oxide 21, thus to form the graphene electrode which is patterned on the substrate 30.

In conclusion, the manufacturing method of the graphene electrode of the present invention, the etching is not required for the patterning of the graphene electrode and the patterned metal material in combination with the CVD process is not required for the patterning of the graphene, either. In the manufacturing method of the present invention, the laser light directly irradiates on the predetermined pattern area of the graphene electrode. The graphene and/or the reduced graphene oxide of the predetermined pattern area are adsorbed and adhered on the substrate and can be separated from the graphene, which is not irradiated by the laser light to form the graphene electrode which is patterned on the substrate. Not only the manufacturing process is simplified but also the difficulty of the patterning of the graphene electrode is reduced. Thus, the processing cost is greatly reduced.

The present invention further provides a liquid crystal display panel. The electrode in the liquid crystal display panel is a graphene electrode, and the graphene electrode is manufactured by the foregoing method.

In the description of the present specification, the reference terms, “one embodiment”, “some embodiments”, “an illustrative embodiment”, “an example”, “a specific example”, or “some examples” mean that such description combined with the specific features of the described embodiments or examples, structure, material, or characteristic is included in the utility model of at least one embodiment or example. In the present specification, the terms of the above schematic representation do not certainly refer to the same embodiment or example. Meanwhile, the particular features, structures, materials, or characteristics which are described may be combined in a suitable manner in any one or more embodiments or examples.

The detail description has been introduced above for the manufacturing method of the graphene electrode and the liquid crystal display panel provided by the embodiment of the invention. Herein, a specific case is applied in this article for explain the principles and specific embodiments of the present invention have been set forth. The description of the aforesaid embodiments is only used to help understand the method of the present invention and the core idea thereof; meanwhile, for those of ordinary skill in the art, according to the idea of the present invention, there should be changes either in the specific embodiments and applications but in sum, the contents of the specification should not be limitation to the present invention.

What is claimed is:

1. A manufacturing method of a graphene electrode, comprising steps of:
providing a support plate and forming a graphene layer on the support plate;
providing a substrate and covering the graphene layer with the substrate;
irradiating the substrate corresponding to a desired pattern area of the graphene layer with laser light so that the desired pattern area of the graphene layer is adsorbed on the substrate;
cooling the substrate so that a portion of the substrate irradiated by the laser light is adhered with the graphene layer which is adsorbed; and
separating the substrate and the graphene layer adhered to the substrate from the support plate to form the graphene electrode which is patterned on the substrate.

2. The manufacturing method of the graphene electrode according to claim 1, wherein the substrate is a flexible substrate made of a polyethylene terephthalate material or a polyimide material.

3. The manufacturing method of the graphene electrode according to claim 1, wherein after the step of providing the support plate and forming the graphene layer on the support plate, the manufacturing method further comprises a step of:
baking the support plate bearing the graphene layer at 50 degrees Celsius to 80 degrees Celsius.

4. The manufacturing method of the graphene electrode according to claim 1, wherein the laser light is carbon dioxide laser, semiconductor laser or fiber laser.

5. The manufacturing method of the graphene electrode according to claim 1, wherein the step of irradiating the substrate corresponding to the desired pattern area of the graphene layer with the laser light comprises:
moving a laser beam on the substrate along the desired pattern area of the graphene layer; or
irradiating the substrate with a planar laser light source and a patterned mask to irradiate the substrate corresponding to the desired pattern area of the graphene layer with the laser light through the mask.

6. The manufacturing method of the graphene electrode according to claim 1, wherein the step of irradiating the substrate corresponding to the desired pattern area of the graphene layer with the laser light so that the desired pattern area of the graphene layer is adsorbed on the substrate comprises:
graphene of the desired pattern area of the graphene layer capturing energy of the laser light to generate heat and the heat melting the substrate in a region irradiated by the laser light to adsorb the graphene which contacts the substrate at a melting position by melting the substrate.

7. The manufacturing method of the graphene electrode according to claim 6, wherein the step of cooling the substrate so that the portion of the substrate irradiated by the laser light is adhered with the graphene layer which is adsorbed comprises:
cooling the portion of the substrate, which is melted to be solidified to adhere the graphene adsorbed at the portion of the substrate, which is melted, on the substrate.

8. The manufacturing method of the graphene electrode according to claim 1, wherein the graphene layer is formed with graphene and/or graphene oxide as a raw material by spraying, coating or chemical vapor deposition.

9. The manufacturing method of the graphene electrode according to claim 7, wherein the graphene layer is formed with graphene and/or graphene oxide as a raw material by spraying, coating or chemical vapor deposition.

10. The manufacturing method of the graphene electrode according to claim 8, wherein as the graphene layer comprises the graphene oxide, after the desired pattern area of the graphene layer is irradiated by the laser light, the graphene oxide is reduced to be reduced graphene oxide which is adsorbed and adhered on the substrate.

11. A liquid crystal display panel, comprising a graphene electrode, wherein the graphene electrode is manufactured by a manufacturing method, and the manufacturing method comprises:
providing a support plate and forming a graphene layer on the support plate;
providing a substrate and covering the graphene layer with the substrate;
irradiating the substrate corresponding to a desired pattern area of the graphene layer with laser light so that the desired pattern area of the graphene layer is adsorbed on the substrate;
cooling the substrate so that a portion of the substrate irradiated by the laser light is adhered with the graphene layer which is adsorbed; and
separating the substrate and the graphene layer adhered to the substrate from the support plate to form the graphene electrode which is patterned on the substrate.

12. The liquid crystal display panel according to claim 11, wherein the substrate is a flexible substrate made of a polyethylene terephthalate material or a polyimide material.

13. The liquid crystal display panel according to claim 11, wherein after the step of providing the support plate and forming the graphene layer on the support plate, the manufacturing method further comprises a step of:
baking the support plate bearing the graphene layer at 50 degrees Celsius to 80 degrees Celsius.

14. The liquid crystal display panel according to claim 11, wherein the laser light is carbon dioxide laser, semiconductor laser or fiber laser.

15. The liquid crystal display panel according to claim 11, wherein the step of irradiating the substrate corresponding to the desired pattern area of the graphene layer with the laser light comprises:
moving a laser beam on the substrate along the desired pattern area of the graphene layer; or
irradiating the substrate with a planar laser light source and a patterned mask to irradiate the substrate corresponding to the desired pattern area of the graphene layer with the laser light through the mask.

16. The liquid crystal display panel according to claim 11, wherein the step of irradiating the substrate corresponding to the desired pattern area of the graphene layer with the laser light so that the desired pattern area of the graphene layer is adsorbed on the substrate comprises:
graphene of the desired pattern area of the graphene layer capturing energy of the laser light to generate heat and the heat melting the substrate in a region irradiated by the laser light to adsorb the graphene which contacts the substrate at a melting position by melting the substrate.

17. The liquid crystal display panel according to claim 16, wherein the step of cooling the substrate so that the portion of the substrate irradiated by the laser light is adhered with the graphene layer which is adsorbed comprises:
cooling the portion of the substrate, which is melted to be solidified to adhere the graphene adsorbed at the portion of the substrate, which is melted, on the substrate.

18. The liquid crystal display panel according to claim 11, wherein the graphene layer is formed with graphene and/or graphene oxide as a raw material by spraying, coating or chemical vapor deposition.

19. The liquid crystal display panel according to claim 17, wherein the graphene layer is formed with graphene and/or graphene oxide as a raw material by spraying, coating or chemical vapor deposition.

20. The liquid crystal display panel according to claim 18, wherein as the graphene layer comprises the graphene oxide, after the desired pattern area of the graphene layer is irradiated by the laser light, the graphene oxide is reduced to be reduced graphene oxide which is adsorbed and adhered on the substrate.
